(19) United States
(12) Patent Application Publication
(10) Pub. No.: US 2007/0064959 A1
(43) Pub. Date: Mar. 22, 2007

(54) Microphone system

(76) Inventor: Arthur Boothroyd, San Diego, CA (US)

Correspondence Address: David L Henty;Myers Dawes Andras & Sherman, Suite 1150, 19900 MacArthur Boulevard, Irvine, CA, 92612, US

(21) Appl. No.: 10/578,788

(22) PCT Filed: Nov. 10, 2004
(86) PCT No.: PCT/US04/37639

§ 371 Date: May 8, 2006

Related U.S. Application Data
(60) Provisional application No. 60/519,236, filed on Nov. 12, 2003.

(51) Int. Cl. H04R 3/00

(52) U.S. Cl. 381/92

(57) ABSTRACT

The invention relates to a method and a system for achieving increased directivity in listening situations where at least one microphone (1, 2, 3) is embedded in a first structure (11) and at least one microphone (4) is embedded in a second structure (10), the first and the second structure being freely movable relative to each other, the method comprising conveying a microphone signal from one structure (11) to a common processing unit (8) for the microphone signals in the other structure (10) and successively processing the signals for achieving a directional output based on the microphone input to both structures.

The invention relates to the area of hearing devices and assistive listening devices, which are used by hearing-impaired individuals. More specifically the invention relates to the field of microphone arrays used in connection with or implemented in such hearing devices and/or assistive listening devices in order to achieve an increased directivity in a particular listening situation.

### BACKGROUND OF THE INVENTION

It is well known how to provide directivity by means of microphone arrays disposed either in a hearing aid or in a separate device connected to a hearing aid. Directivity should in this context be understood as increased sensitivity to sound received from a certain direction relative to other directions.

These previously known devices and the methods associated with them do provide a certain element of directivity to the individual using the system, thereby providing help to this individual in difficult listening situations, e.g. noisy listening situations, by providing an opportunity to focus on a desired target and to reduce the input of surrounding noise signals. However since the previously known devices, due to size issues, have been limited to achieve the increased directivity for relatively high frequencies the individual has not been able to obtain the same benefit in the low frequency range and hence there have so far been a significant lack of information from the desired signal to the individual. This problem is especially serious for hearing-impaired individuals who, by virtue of their pathology, must rely mainly on low-frequency information for speech perception.

Due to this fact the objectives of the present invention are to provide a method, a microphone array, a hearing system, as well as a hearing aid and a microphone unit that besides the high-frequency directivity will be able to provide the desired low-frequency benefit in the same listening situation.

### SUMMARY OF THE INVENTION

The primary objective is according to the invention achieved by means of the method defined in claim 1.

By means of such method the directivity in the low frequency area may be increased significantly without the need of increasing the size of the physical equipment correspondingly.

The second objective is achieved by means of the microphone array as defined in claim 5.

As explained above such microphone array may improve the directivity in the lower frequency area.

The third objective is achieved by means of the hearing system as defined in claim 10. Such hearing aid system implements the fundamentals of the above-mentioned principles in a hearing aid and due to the use of the existing microphone a significant synergy is achieved.

The fourth objective is achieved by means of a hearing aid as defined in claim 12. This hearing aid forms part of a hearing system as described above.

The fifth objective is achieved by means of a microphone unit as defined in claim 14. This microphone unit forms part of a hearing system as described above.

Advantageous embodiments are defined in the sub claims referring to the above-mentioned main claims.

More details will become apparent in the following description of preferred embodiments, with reference to the drawings.

### BRIEF DESCRIPTION OF THE DRAWINGS

FIG. 1 is a schematic drawing depicting a system according to the invention;

FIG. 2 is a schematic drawing depicting a hearing system according to the invention;

FIG. 3 is a schematic drawing depicting a microphone array and further depicting the principles of increasing the microphone distance;

FIG. 4 shows simulated attenuation at different angles in connection with a known system;

FIG. 5 shows simulated attenuation at different angles in connection with a first system according to the invention;

FIG. 6 shows simulated attenuation at different angles in connection with a second system according to the invention.

### DESCRIPTION OF A PREFERRED EMBODIMENT

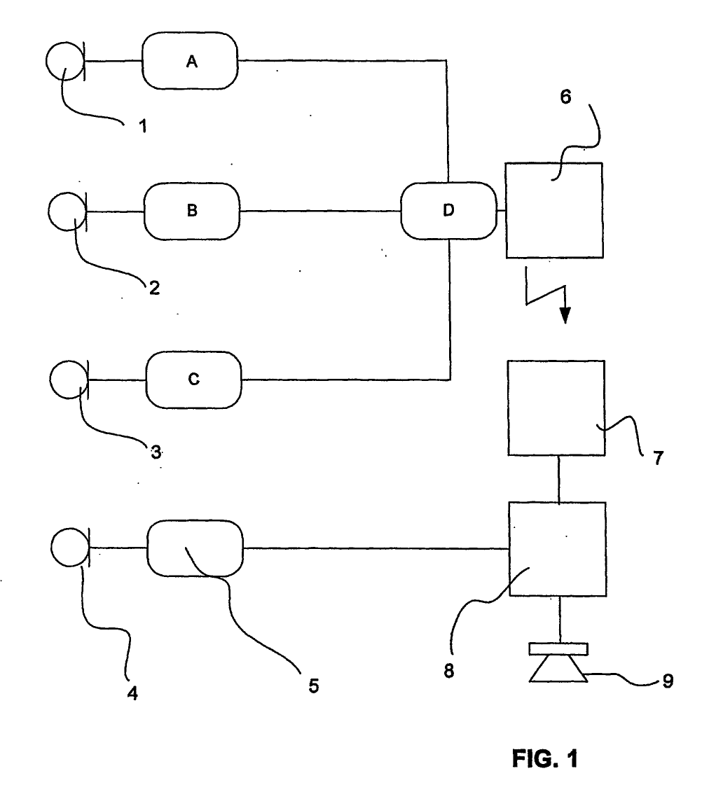

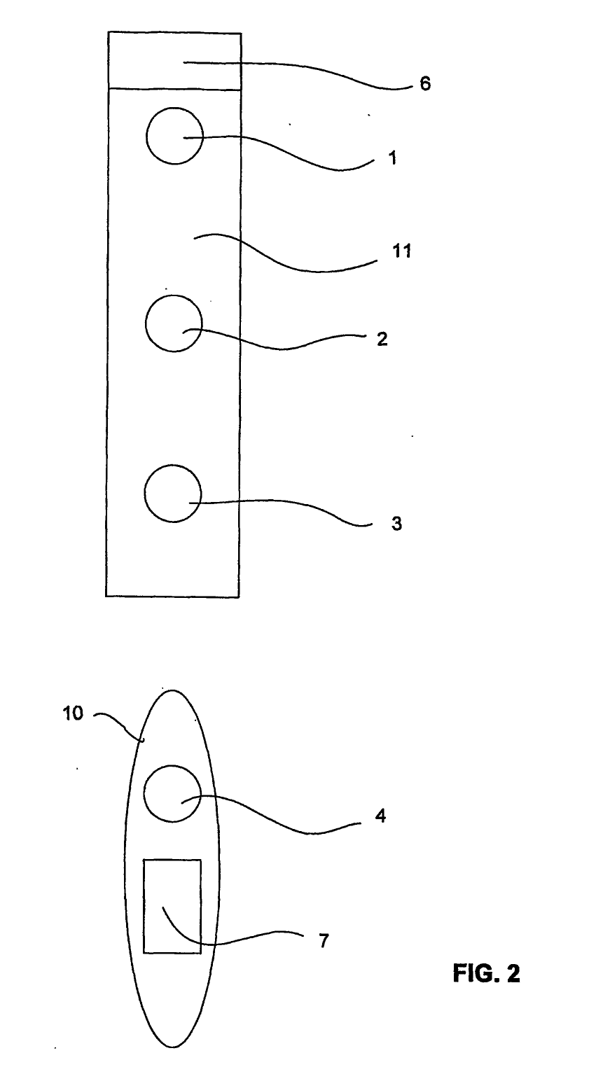

From FIG. 1 and FIG. 2 a system according to the invention appears. The system comprises a hearing aid and a separate microphone unit. FIG. 1 shows schematically the connection of the various elements and FIG. 2 shows schematically the embedded solution as a portable microphone unit 11 and a hearing aid 10.

The hearing aid 10 comprises a signal path with a microphone 4, a preamplification unit 5, a processing unit 8 and an output transducer 9. In addition to this the hearing aid comprises a receiver 7 for receiving wireless transmitted signals. Circuitry is provided for conveying the received signals to the processing unit.

The separate microphone unit 11 comprises three microphones 1,2,3 with individual preamplifiers A,B,C and a transmitter 6 for wireless transmission of microphone signals to the hearing aid. A processor D is present for local processing of microphone signals.

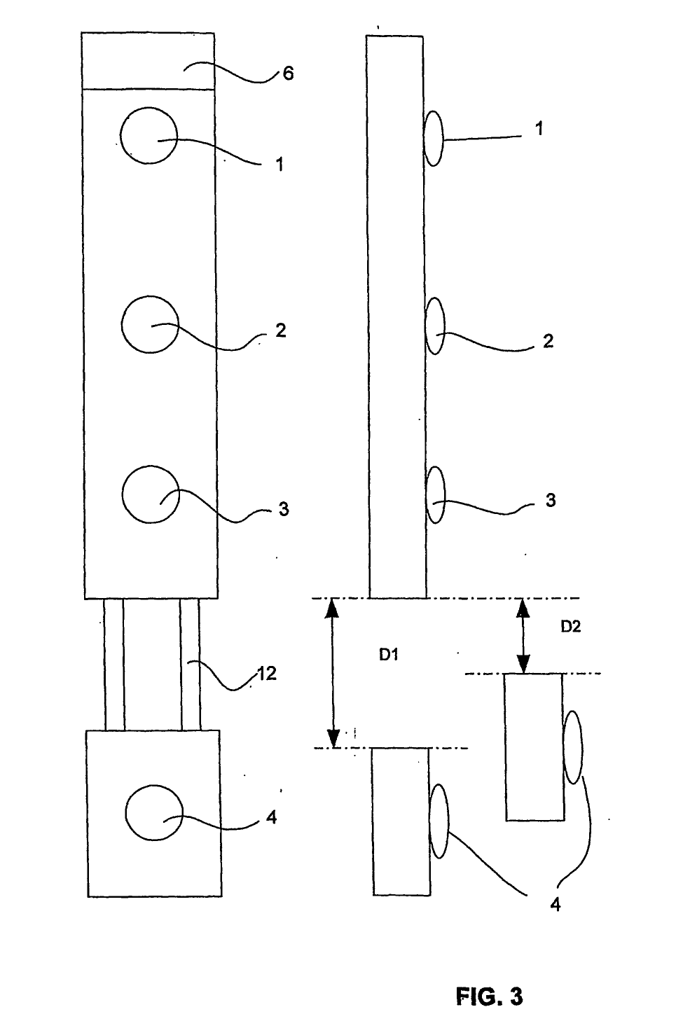

FIG. 3 depicts a system involving a microphone system comprising two units, which are interconnected. Each of the two units comprises at least one microphone; in the example shown three microphones 1,2,3 are mounted in a first unit and one microphone 4 in a second unit. The two units may be displaced relative to each other thereby increasing or decreasing the distance between the microphones in the first and in the second unit. The two units are here shown sliding along sliding rods 12. This is shown more clearly in FIG. 3, where two different positions with the distances D1 and D2 between the units are shown. When increasing the distance between the two units and hence the microphones an increased directivity for lower frequencies may be obtained. The distance between the microphones is important in relation to the actual frequency area that is targeted for increased directivity. Lower frequencies require longer distances between the microphones due to the longer wavelength of the lower-frequency sound signals.

When having the two units interconnected it may be possible to have a sensor or the like to determine the actual position of the second unit relative to the first and hence have accurate information on the distance, which may be important to the directivity processing.

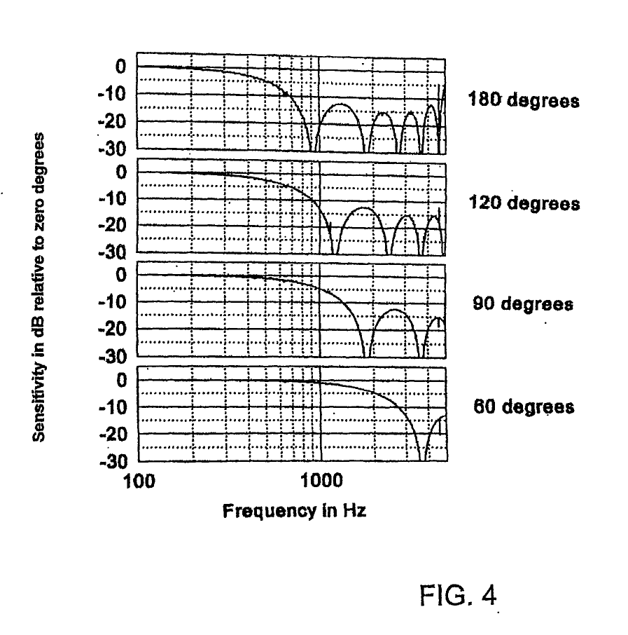

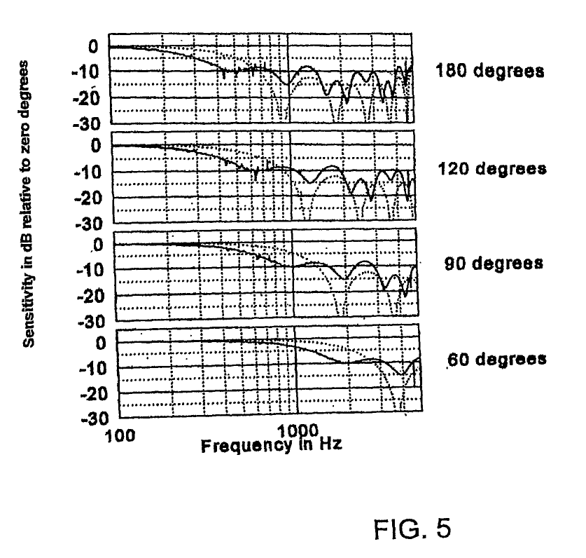

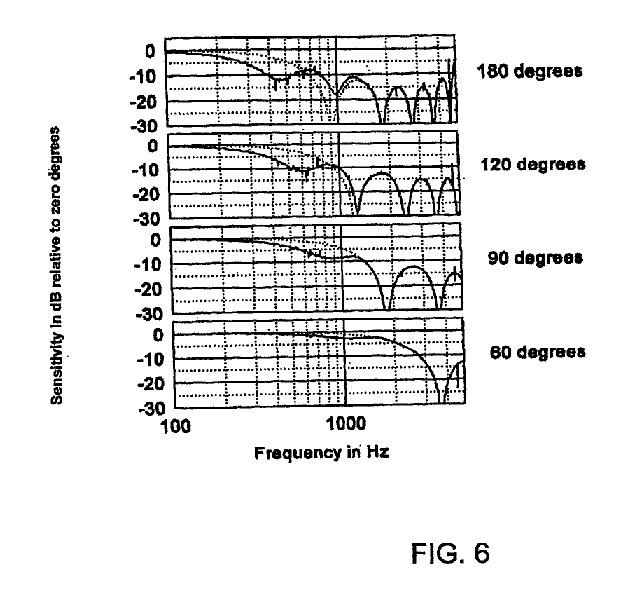

FIGS. 4, 5 and 6 show attenuation of signals at different angles. The curve shown in FIG. 4 shows the simulated attenuation of incoming signals in a usual microphone array. In the curve shown in FIG. 5 the off-axis sensitivity is shown for a system according to the invention, where an additional microphone has been placed at a distance from the array used in connection with the previous simulation, the result of which is shown in FIG. 4. It becomes apparent from FIG. 5 that the off-axis low-frequency attenuation is greater (i.e., sensitivity is lower) in this system according to the invention. In the curve shown in FIG. 6 the attenuation is shown for a system according to the invention, where an additional microphone has been placed at a distance from the array used in connection with the previous simulation, the result of which is shown in FIG. 4. In addition to this, low-pass filtering of the signal arising from the additional microphone has been implemented. It becomes apparent that the off-axis low-frequency attenuation has been further improved, without compromising the off-axis attenuation in the higher frequencies, i.e. even greater directivity is achieved, in this system according to the invention.

When obtaining the directivity from the microphone signals simple well known sum-delay principles may be utilized, however any other principle may be used in the directivity processing.

1. A method for achieving increased directivity in listening situations where at least one microphone is embedded in a first structure and at least one microphone is embedded in a second structure, the first and the second structure being freely movable relative to each other, the method comprising conveying a microphone signal from one structure to a common processing unit for the microphone signals in the other structure and successively processing the signals for achieving a directional output based on the microphone input in both structures.

2. A method according to claim 1, where the signal to be transmitted from one structure to another structure is delayed.

3. A method according to claim 1 or 2, where the microphone signal of the one structure is amplified, attenuated, low-pass filtered and/or phase shifted to optimise the directivity.

4. A method according to claim 1,2 or 3, where in addition the distance and/or the spatial position of the one microphone is determined and conveyed to the processing unit.

5. A microphone array for achieving increased directivity in listening situations, where the array comprises at least two microphones for producing a corresponding number of microphone signals, where one microphone is embedded in a first structure and a second microphone is embedded in a second structure, the first and the second structure being movable relative to each other to increase or decrease the distance between the microphones in the first structure and the second structure, where means are provided for conveying the signals from at least one microphone to a common processing unit for the microphone signals.

6. A microphone array according to claim 5, where the distance between a microphone in the first structure and a microphone in the second structure may be brought to a mutual distance facilitating directivity processing below 1000 Hz.

7. A microphone array according to claim 5, where in addition means for determining the distance and/or the spatial position of the one microphone relative to the other.

8. A microphone array according to claim 7 where, in addition, there are means for conveying the position to the processing unit.

9. A microphone array according to any of the claims 5-8, where means are provided for conveying a microphone array signal to a head-worn device, e.g. a hearing aid, where these means for conveying may comprise a Radio Frequency (RF), inductive, Infra-Red (IR), wired or other transmission link.

10. A hearing system comprising a hearing aid and a separate microphone unit, where the microphone unit has at least one microphone unit and a transmitting capability enabling transmission of at least one microphone signal to the hearing aid, which on its side comprises a receiving capability for receiving the transmitted signal, a signal processing unit for processing the received microphone signal together with a microphone signal obtained by a microphone in the hearing aid and eventually preparing a processed directional signal for output through an output transducer in the hearing aid.

11. A hearing system according to claim 10, where the transmitting capability may comprises wireless a RF, inductive or IR transmission link or a wired link.

12. A hearing aid for use in a system as defined in claim 10, where means are provided for receiving an additional external microphone input and for conveying these to a processing unit in the hearing aid, where the processing unit is adapted to provide a directional output based on the microphone inputs.

13. A hearing aid according to claim 12, comprising a wireless receiver for receiving microphone input signals from an independent microphone unit.

14. A microphone unit for use in a system as defined in claim 10, the unit comprising at least one microphone and a transmitter for transmitting a microphone signal to a hearing aid comprising a receiver.

15. A microphone unit according to claim 14, comprising a wireless transmitter for transmitting microphone input signals to an independent hearing aid unit.
